(19) United States
(12) Patent Application Publication
(10) Pub. No.: US 2010/0062394 A1
(43) Pub. Date: Mar. 11, 2010

(54) PREFORMED MALLEABLE MULTILAYER DENTAL ARTICLES

(76) Inventors: Todd D. Jones, St. Paul, MN (US); Naimul Karim, St. Paul, MN (US); Dwight W. Jacobs, Hudson, WI (US)

Correspondence Address: 3M INNOVATIVE PROPERTIES COMPANY, PO BOX 33427, ST. PAUL, MN, 55133-3427, US

(21) Appl. No.: 12/440,615

(22) PCT Filed: Sep. 12, 2007
(86) PCT No.: PCT/US07/78235

§ 371 Date: Oct. 20, 2009

Related U.S. Application Data
(60) Provisional application No. 60/825,496, filed on Sep. 13, 2006.

(51) Int. Cl. A61C 13/23; A61C 5/09

(52) U.S. Cl. 433/172; 433/222.1; 433/226

(57) ABSTRACT

A dental article includes an external layer formed of a self-supporting hardenable preformed material having a dental article shape defined by an external layer surface. The external layer defines an interior volume. An interior material is disposed within the interior volume. The interior material is different than the external hardenable preformed material and the interior material has a yield stress value of 100 dyn/cm2 or greater.

### CROSS-REFERENCE TO RELATED APPLICATION

This application claims priority from U.S. Patent Application Ser. No. 60/825,496, filed Sep. 13, 2006.

### BACKGROUND

The present disclosure relates generally to preformed malleable dental articles used in restorative dentistry and methods of using the preformed malleable multilayer dental articles.

Restorative dentistry is an important market in the dental industry. In particular, tooth repair with temporary and permanent dental articles such as, for example, dental crowns or bridges, is a common procedure, often requiring multiple dental appointments. In many instances, practitioners rely on preformed dental articles to expedite the restoration process by providing a dental article in the dental shape being restored.

Preformed crowns that are available in the market today are typically made of metals (e.g., stainless steel, aluminum, metal alloys, etc.) or polymers (e.g. polycarbonate, polyacetal, etc.). Metal crowns can additionally be covered with a tooth colored coating to provide an aesthetic appearance.

If adjustments to the preformed metal and polymer crowns are needed, they can be trimmed with a crown scissors, or other instruments to remove material at the crown margin to obtain a desired crown length. Metal crowns may also be crimped at the cervical region to obtain good marginal adaptation. Modification of other crown dimensions, however, such as interproximal distances, crown anatomy, etc. are not performed because the materials used in the preformed crowns are not amenable to shape adjustment by the practitioner. As a result, these crowns are offered in a very large number of sizes, typically 36 or more for either the posterior or anterior teeth, to sufficiently cover the range of conditions encountered in a dental practice.

These crowns must be lined with either powder/liquid acrylics, bis acrylics, composite or cement, for example, in order to fill the gaps between the interior of the crown and the surface of the prepared tooth. These liner materials often have weaker mechanical properties than the crown material and are applied to the crown right before the crown is set onto the prepared tooth. In addition, liner materials provide at least two interfaces for adhesive failure.

### SUMMARY

In one exemplary implementation, the present disclosure is directed to a dental article that includes an external layer formed of a self-supporting hardenable preformed material having a dental article shape defined by an external layer surface. The external layer defines an interior volume. An interior material is disposed within the interior volume. The interior material is different than the external hardenable preformed material and the interior material has a yield stress value of 100 dyn/cm² or greater.

In another exemplary implementation, the present disclosure is directed to a method of using a self-supporting hardenable preformed multilayer dental article. The method includes providing a dental article having an external layer formed of a self-supporting hardenable preformed material. The external layer has a dental article shape defined by an external layer surface. The external layer defines an interior volume. An interior material is disposed within the interior volume. The interior material is different than the external hardenable preformed material and the interior material has a yield stress value of 100 dyn/cm² or greater. The method also includes pressing the dental article onto a prepared tooth to form a recess in the interior material defined by a recess surface that is complimentary to the prepared tooth surface. The external contour of the dental article can be reshaped adjust to proximal and occlusal or incisal contacts, followed by hardending, as desired.

These and other aspects of the preformed malleable dental articles and method of using preformed malleable dental articles according to the subject invention will become readily apparent to those of ordinary skill in the art from the following detailed description together with the drawings.

### BRIEF DESCRIPTION OF THE DRAWINGS

So that those having ordinary skill in the art to which the subject invention pertains will more readily understand how to make and use the subject invention, exemplary embodiments thereof will be described in detail below with reference to the drawings, in which:

FIG. 1 is a schematic cross-sectional diagram of one illustrative manufacturing process;

FIG. 2 is a schematic cross-sectional view of one illustrative preformed malleable multilayer dental crown;

FIG. 3 is a schematic cross-sectional view of another illustrative preformed malleable multilayer dental crown;

FIGS. 4A-4D are schematic cross-sectional diagrams of one illustrative method of using the preformed malleable multilayer dental crown; and

FIG. 5 is a schematic cross-sectional view of an illustrative packaged dental article.

### DETAILED DESCRIPTION

This disclosure describes preformed multilayer dental articles made of a malleable and hardenable material. The malleable and hardenable material can be cured to form a hard dental composite, suitable for temporary or long term use, i.e., from 2 weeks to more than 5 years, for example. The malleability of this dental article allows for customization from the basic preformed shape. In many embodiments, this dental article has two or more layers of material to allow for accurate fit to dental preparations, particularly small dental preparations such as, for example, heavily reduced anterior teeth and pediatric preparations. The dental articles described herein can provide (a) better esthetics, e.g., by having a multi-chromatic appearance, (b) better overall balance of mechanical properties, (c) better/faster/easier to use, and/or (d) better customization, including a more accurate fit to dental preparations.

Accordingly, the present disclosure is directed generally to preformed malleable dental articles used in restorative dentistry and methods of using the preformed malleable dental articles, and particularly to preformed malleable dental articles that have an exterior malleable hardenable composition layer and one or more interior layers that form an inner dental article surface that can be generally complimentary to a prepared tooth. While the present invention is not so limited, an appreciation of various aspects of the invention will be gained through a discussion of the examples provided below.

The following description should be read with reference to the drawings, in which like elements in different drawings are numbered in like fashion. The drawings, which are not necessarily to scale, depict selected illustrative embodiments and are not intended to limit the scope of the disclosure. Although examples of construction, dimensions, and materials are illustrated for the various elements, those skilled in the art will recognize that many of the examples provided have suitable alternatives that may be utilized.

Unless otherwise indicated, all numbers expressing feature sizes, amounts, and physical properties used in the specification and claims are to be understood as being modified in all instances by the term “about.” Accordingly, unless indicated to the contrary, the numerical parameters set forth in the foregoing specification and attached claims are approximations that can vary depending upon the desired properties sought to be obtained by those skilled in the art utilizing the teachings disclosed herein.

The recitation of numerical ranges by endpoints includes all numbers subsumed within that range (e.g. 1 to 5 includes 1, 1.5, 2, 2.75, 3, 3.80, 4, and 5) and any range within that range.

As used in this specification and the appended claims, the singular forms “a”, “an”, and “the” encompass embodiments having plural referents, unless the content clearly dictates otherwise. As used in this specification and the appended claims, the term “or” is generally employed in its sense including “and/or” unless the content clearly dictates otherwise.

The term “self-supporting” as used herein means that each dental article (e.g., crown) is dimensionally stable and will maintain its preformed shape without significant deformation at room temperature (i.e., about 20° C. to about 25° C.) for at least about two weeks when free-standing (i.e., without the support of packaging or a container). In many embodiments, the preformed dental articles described herein are dimensionally stable at room temperature for at least about one month, or for at least about six months. In some embodiments, the preformed dental articles described herein are dimensionally stable at temperatures above room temperature, or up to about 40° C., or up to about 50° C., or up to about 60° C. This definition applies in the absence of conditions that activate any initiator system and in the absence of an external force other than gravity.

The term “sufficient malleability” means that the self-supporting preformed dental article is capable of being custom-shaped and fitted onto a prepared tooth under a moderate manual force (i.e., a force that ranges from light finger pressure to that applied with manual operation of a small hand tool, such as a dental composite instrument). The shaping, fitting, forming, etc., can be performed by adjusting the external shape and internal cavity shape of the preformed dental article without adding material or removing material other than at or adjacent the margin.

The term “dental article” includes dental restoratives or dental prostheses such as, temporary, intermediate, and permanent crowns, bridges, implants, dentures, and artificial teeth.

In many embodiments, the preformed dental articles described herein consist essentially of a hardenable composition. The hardenable compositions used in preformed dental articles described herein may exhibit the desired “sufficient malleability” at temperatures of, e.g., 40 degrees Celsius or less. In other instances, the hardenable compositions may exhibit “sufficient malleability” in a temperature range of, e.g., 15° C. to 38° C.

In many embodiments, the hardenable compositions of the preformed dental articles described herein are “irreversibly hardenable” which, as used herein, means that after hardening such that the composition loses its malleability it cannot be converted back into a malleable form without destroying the external shape of the dental article.

Examples of some potentially suitable hardenable compositions that may be used to construct the preformed dental article described herein with sufficient malleability may include, e.g., hardenable organic compositions (filled or unfilled), polymerizable dental waxes, hardenable dental compositions having a wax-like or clay-like consistency in the unhardened state, etc. In some embodiments, the preformed dental articles are constructed of hardenable compositions that consist essentially of non-metallic materials.

Potentially suitable hardenable compositions that may be used to manufacture the preformed dental articles of the present invention may be described in U.S. Patent Application Publication No. US 2003/0114553, titled HARDENABLE SELF-SUPPORTING STRUCTURES AND METHODS (Karim et al.). Other suitable hardenable compositions may include those described in U.S. Pat. No. 5,403,188 (Oxman et al.); U.S. Pat. No. 6,057,383 (Volkel et al.); and U.S. Pat. No. 6,799,969 (Sun et al.).

Organogelators described in 3M Attorney Docket Number 61991US002 titled “DENTAL COMPOSITIONS INCLUDING ORGANOGELATORS, PRODUCTS, AND METHODS” filed on even date with this application can be utilized in combination with the hardenable compositions and/or interior marterials in the dental articles described herein. These organgelator compositions can be flowable, packable, or self-supporting. The term “organogelator” means a low molecular weight compound (generally no greater than 3000 grams per mole) that forms a three-dimensional network structure when dissolved in an organic fluid, thereby immobilizing the organic fluid and forming a non-flowable thermally-reversible gel.

With respect to the hardenable compositions described in US 2003/0114553, the unique combination of highly malleable properties (preferably without heating above room temperature or body temperature) before hardening (e.g., cure) and high strength (preferably, e.g., a flexural strength of at least about 25 MPa) after hardening may provide preformed dental articles with numerous potential advantages.

As discussed herein, the preformed dental article hardenable compositions are sufficiently malleable to facilitate forming of preformed dental article onto a prepared tooth during the fitting process. Because the compositions are hardenable, the adjusted external shape can be retained.

As described above, useful hardenable compositions for the preformed dental articles described herein may include, e.g., polymerizable waxes, hardenable organic materials (filled or unfilled), etc. Some potentially suitable hardenable compositions may include those described in U.S. Pat. No. 5,403,188 (Oxman et al.); U.S. Pat. No. 6,057,383 (Volkel et al.); and U.S. Pat. No. 6,799,969 (Sun et al.). Other hardenable compositions that may be used to manufacture the preformed dental articles described herein may be described in U.S. Patent Application Publication No. US 2003/0114553, titled HARDENABLE SELF-SUPPORTING STRUCTURES AND METHODS (Karim et al.). As described therein (and briefly summarized in the following discussion), a hardenable composition of US 2003/0114553 may include a resin system that includes a crystalline component, greater than 60 percent by weight (wt-%) of a filler system (preferably, greater than 70 wt-% of a filler system), and an initiator system, wherein the hardenable composition exhibits sufficient malleability to be formed onto a prepared tooth, preferably at a temperature of about 15° C. to 38° C. (more preferably, about 20° C. to 38° C., which encompasses typical room temperatures and body temperatures). In some embodiments, the hardenable compositions do not need to be heated above body temperature (or even about room temperature) to become malleable as discussed herein.

In many embodiments, at least a portion of the filler system of the hardenable compositions of US 2003/0114553 includes particulate filler. In this and various other embodiments, if the filler system includes fibers, the fibers are present in an amount of less than 20 wt-%, based on the total weight of the composition.

The crystalline component may provide a morphology that assists in maintaining the self-supporting first shape. This morphology includes a noncovalent structure, which may be a three-dimensional network (continuous or discontinuous) structure. If desired, the crystalline component can include one or more reactive groups to provide sites for polymerizing and/or crosslinking. If such crystalline components are not present or do not include reactive groups, such reactive sites are provided by another resin component, such as an ethylenically unsaturated component.

Thus, for certain embodiments, the resin system includes at least one ethylenically unsaturated component. Ethylenically unsaturated components can be selected from the group consisting of mono-, di-, or poly-acrylates and methacrylates, unsaturated amides, vinyl compounds (including vinyl oxy compounds), and combinations thereof. This ethylenically unsaturated component can be the crystalline component or noncrystalline.

The crystalline component can include polyesters, polyethers, polyolefins, polythioethers, polyarylalkylenes, polysilanes, polyamides, polyurethanes, or combinations thereof. The crystalline component can include saturated, linear, aliphatic polyester polyols containing primary hydroxyl end groups. The crystalline component can optionally have a dendritic, hyperbranched, or star-shaped structure, for example.

The crystalline component can optionally be a polymeric material (i.e., a material having two or more repeat units, thereby including oligomeric materials) having crystallizable pendant moieties and the following general formula:

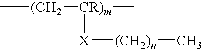

wherein R is hydrogen or a (C₁-C₄)alkyl group, X is —CH₂—, —C(O)O—, —O—C(O)—, —C(O)—NH—, —HN—C(O)—, —O—, —NH—, —O—C(O)—NH—, —HN—C(O)—O—, —HN—C(O)—NH—, or —Si(CH₃)₂—, m is the number of repeating units in the polymer (preferably, 2 or more), and n is great enough to provide sufficient side chain length and conformation to form polymers containing crystalline domains or regions.

Alternative to, or in combination with, the crystalline component, the hardenable composition can include a filler that is capable of providing a morphology to the composition that includes a noncovalent structure, which may be a three-dimensional network (continuous or discontinuous) structure, that assists in the maintenance of the first shape. In some embodiments, such a filler has nanoscopic particles, or the filler is an inorganic material having nanoscopic particles. To enhance the formation of the noncovalent structure, the inorganic material can include surface hydroxyl groups. In some embodiments, the inorganic material includes fumed silica.

Furthermore, the use of one or more surfactants can also enhance the formation of such a noncovalent structure. In some embodiment, the composition includes, in addition to a resin system and an initiator system, either a crystalline component, or a filler system that includes a nanoscopic particulate filler (both a micron-size particulate filler and a nanoscopic particulate filler) and a surfactant system, or both a crystalline component and a filler system and surfactant system. As used herein, a filler system includes one or more fillers and a surfactant system includes one or more surfactants.

Another potential embodiment of the hardenable compositions that may be used in the preformed dental articles of the invention may include a hardenable composition of US Patent Application Publication No. 2003/0114553 that includes a resin system, a filler system at least a portion of which is an inorganic material having nanoscopic particles with an average primary particle size of no greater than about 50 nanometers (nm), a surfactant system, and an initiator system. The hardenable composition can exhibit sufficient malleability to be formed onto a prepared tooth at a temperature of about 15° C. to 38° C. In embodiments with a surfactant system and nanoscopic particles, the resin system can include at least one ethylenically unsaturated component, and the filler system is present in an amount of greater than 50 wt-%.

In other potentially preferred embodiments, hardenable compositions may include a resin system that includes: a noncrystalline component selected from the group consisting of mono-, di-, or poly-acrylates and methacrylates, unsaturated amides, vinyl compounds, and combinations thereof; and a crystalline component selected from the group consisting of polyesters, polyethers, polyolefins, polythioethers, polyarylalkylenes, polysilanes, polyamides, polyurethanes, polymeric materials (including oligomeric materials) having crystallizable pendant moieties and the following general formula:

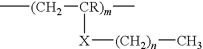

wherein R is hydrogen or a (C₁-C₄)alkyl group, X is —CH₂—, —C(O)O—, —O—C(O)—, —C(O)—NH—, —HN—C(O)—, —O—, —NH—, or —O—C(O)—NH—, —HN—C(O)—O—, —HN—C(O)—NH—, or —Si(CH₃)₂—, m is the number of repeating units in the polymer (preferably, 2 or more), and n is great enough to provide sufficient side chain length and conformation to form polymers containing crystalline domains or regions, and combinations thereof. The hardenable composition further includes greater than about 60 wt-% of a filler system and an initiator system. The hardenable composition can exhibits sufficient malleability to be formed onto a prepared tooth at a temperature of about 15° C. to 38° C. If the filler system includes fibers, the fibers may be present in an amount of less than 20 wt-%, based on the total weight of the hardenable composition.

In yet another embodiment, the hardenable compositions includes a resin system with a crystalline compound of the formula:

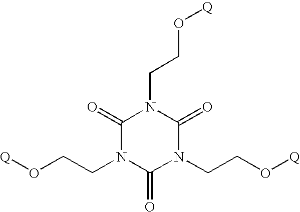

wherein each Q independently comprises polyester segments, polyamide segments, polyurethane segments, polyether segments, or combinations thereof; a filler system; and an initiator system.

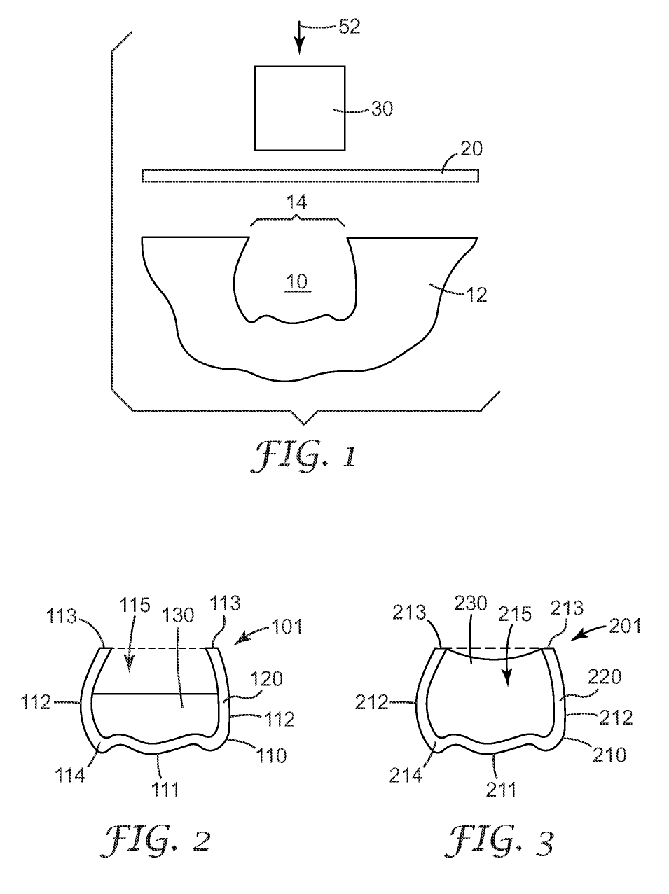

FIG. 1 is a schematic cross-sectional diagram of one illustrative manufacturing process. The illustrated process includes a mold cavity 10 formed in a body 12. The mold cavity 10 includes an opening 14 leading to the volume of the mold cavity itself, which is depicted in cross-section in FIG. 1. In the depicted embodiment, the mold cavity 10 is in the shape of a molar dental crown. It should, however, be understood that the mold cavity 10 can have any dental shape to mimic, for example, an incisor, canine, pre-molar, molar.

The mold body 12 may be formed in any suitable material or combination of materials, e.g., metals, polymeric materials, etc. that provide sufficient structural integrity to withstand the forming process as described herein. In some instances, the mold body 12 may be formed in separable sections to facilitate removal of a multilayer dental article formed therein. Also, the mold body 12 may be made of or coated with a material adapted to aid release of the multilayer dental article from the interior surfaces of the mold cavity 10. For example, the interior surfaces of the mold cavity 10 may be coated with, e.g., fluorinated polymers (e.g., PTFE, etc.), boron carbide, chrome, thin dense chrome, chromium nitride, electroless nickel infused with fluorinated polymers, modified tungsten disulfide (e.g., DICRONITE), etc.

In other variations, the mold cavity 10 may be temperature controlled to assist in the molding process by, e.g., heating and/or cooling the temperature of the interior surfaces of the mold cavity 10. In yet other variations, the mold cavity 10 may be vented or evacuated during the molding process to enhance molding. Ultrasonic or other vibrational energy may also be used to enhance filling of the mold cavity 10 and/or assist with release the article from the mold cavity 10.

A mass of external hardenable dental material 20 is disposed between the opening 14 and a mass of interior material 30. The mass of external hardenable dental material 20 is illustrated as a layer of material prior to entering the mold cavity 10, however mass of external hardenable dental material 20 can be provided in any shape or form prior to entering the mold cavity 10.

The mass of external hardenable dental material 20 and mass of interior material 30 are disposed (simultaneously or sequentially) into the mold cavity 10 through the opening 14 therein. As a result, the mass of hardenable dental material 20 and mass of interior material 30 are advanced in the direction of arrow 52 as depicted in FIG. 1.

The mass of hardenable dental material 20 can be pre-formed into a shape suitable for molding into the desired finished dental article. The hardenable dental material 30 forms an external layer where the interior material 30 is disposed.

The process illustrated in FIG. 1 can be described as a compression molding process. It should, however, be understood that the hardenable dental material 20 may be formed into the external layer shape by any suitable process. Some suitable processes may include, but are not limited to, e.g., injection molding, forging, casting, vacuum forming, extrusion molding, thermoforming, transfer molding, blow molding, etc.

In some embodiments, a mold liner (not shown) is disposed between the mold cavity 10 body 12 and the mass of hardenable dental material 20. An optional top liner (not shown) can be disposed over the mass of interior material 30 such that the multilayer dental article is disposed between the mold liner and the top liner. These two liners can provide a packaging for the preformed malleable dental article until it is used.

The mold liner and top liner can be constructed of a variety of different materials. For example, these liners can be manufactured of a deformable material that may be provided in sheet form over the opening 14 of the mold cavity 10 and deformed under the molding conditions (e.g., temperature, pressure, etc.) used to form the hardenable dental material 20 into the desired shape. Examples of some suitable materials for the liners can include, but are not limited to, e.g., polypropylenes, polyethylenes, polyurethanes, vinyls, thermoplastic elastomers, elastomeric films (e.g., rubber, latex, etc.), fluorinated polymers (e.g., FEP, PFA, THV, ECTFE, etc.), plasticized PVC, elastic-plastic films (e.g., blends of, for example, block copolymers of styrene and butadiene, and polypropylene), copolymers (e.g., copolymers of ethylene and vinyl acetate or ethylene and ionic monomers, such as those sold under the tradename SURYLON by Dupont Chemical (Wilmington, Del.)), water soluble polymers (e.g., selected from the group consisting of polyvinylpyrrolidones, polyvinylpyrrolidone/vinyl acetate copolymers, polyvinyl alcohols, polyethylene oxides, polyacrylamides, polyacrylic acids, polysaccharides and synthetically modified polysaccharides (e.g., cellulose ether polymers), alginates (e.g., sodium alginate), polyethyl oxazolines, esters of polyethylene oxide, esters of polyethylene oxide and polypropylene oxide copolymers, urethanes of polyethylene oxide, urethanes of polyethylene oxide and polypropylene oxide copolymers, etc.). Further, these liners can include one or more coatings (e.g., silicone, etc.) to enhance formability, release from the preformed multilayer dental article, etc.

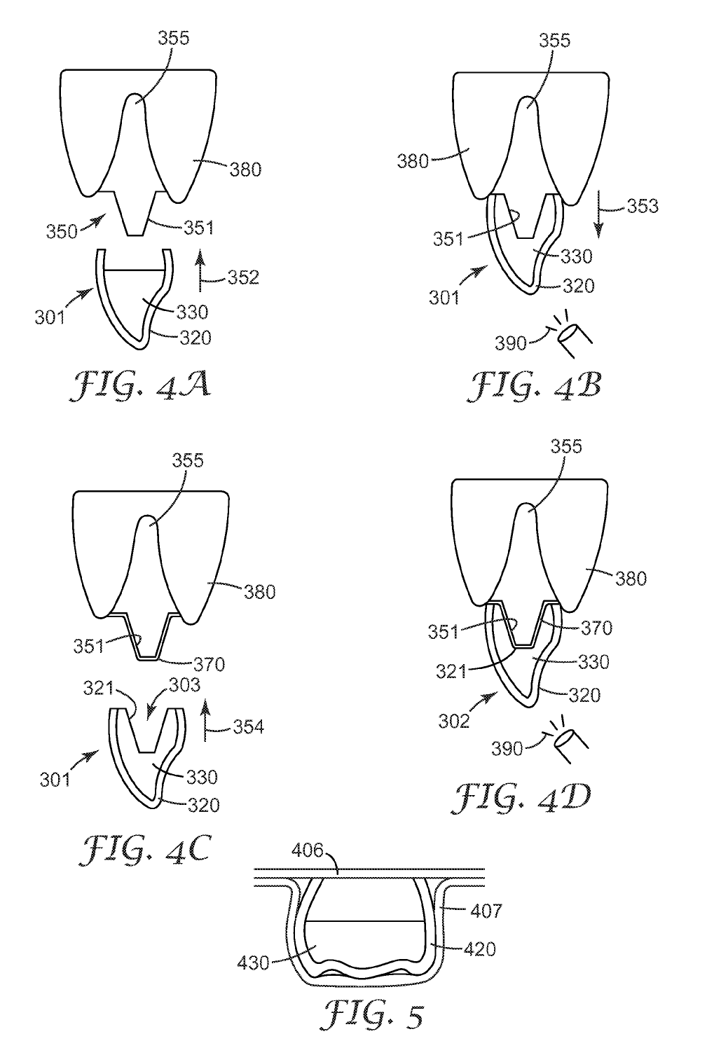

After removing the hardenable dental material 20 and mass of interior material 30 from the mold cavity 10, the now molded multilayer dental article (depicted in FIGS. 2 and 3) are ready to be used (depicted in FIGS. 4A-4D) by a clinician once it is removed from any packaging (e.g. liners, depicted in FIG. 5).

FIG. 2 is a schematic cross-sectional view of one illustrative preformed malleable multilayer dental crown 101. The preformed malleable multilayer dental crown 101 is also referred to as a self-supporting multilayer hardenable preformed dental crown 101.

The preformed malleable multilayer dental crown 101 has an external layer 120 defined by an external layer surface 110. The external layer surface 110 defines an interior volume 115. The interior material 130 is disposed within the interior volume 115 via any useful method such as, for example, painting, injection coating, and the like. The external layer 120 is formed from the hardenable composition described above. This external layer 120 hardenable composition has sufficient malleability such that the preformed malleable multilayer dental article exterior shape can be altered by the application of pressure onto the external layer 120.

The interior material 130 is different than the material that forms the external layer 120. In some embodiments, the interior material 130 possesses a different optical property than the material that forms the external layer 120. For example, the interior material 130 can possess a different color, shade or opacity than the external layer 120. In some of these embodiments, the interior material 130 is the same hardenable material (described above) that forms the external layer 120, except for the addition of a dye, pigment, radio-opacifying agent, and/or other material. In some embodiments, the interior material 130 is a different hardenable material than the hardenable material that forms the external layer 120,

In some embodiments, the interior material 130 possesses a different curing property than the material that forms the external layer 120. For example, the interior material 130 can cure at a first range of radiation wavelengths and the external layer 120 can cure at a second range of radiation wavelengths. Alternatively, the interior material 130 and the external layer 120 can cure by two separate mechanisms (e.g., radiation cure vs. thermal cure). Thus, the interior material 130 can be cured independently of the external layer 120. In some embodiments, the interior material 130 and the external layer 120 can cure at different rates or speeds even if the cure mechanisms and the range of radiation wavelengths at which they cure or identical or substantially similar.

Dental practitioners generally desire good handling properties in a dental material, as it often translates to time savings. For example, in dental restorative work, it is desirable that dental materials do not slump because after a practitioner places the material in the mouth and manipulates the material by contouring and feathering, the practitioner generally wants the imparted shape to remain unchanged until the material is hardened. Materials used for restorative work, having a sufficiently high yield stress, generally will not slump; that is, they will not flow under only the stress of gravity. The yield stress of a material is the minimum stress required to cause the material to flow. If the stress due to gravity is below the yield stress of the material, then the material will not flow. The stress due to gravity, however, will depend on the mass of dental material being placed as well as the shape.

The method of measuring yield stress is defined by the following method. Approximately 4 g of a composite paste is loaded between 50 mm diameter parallel plates in an ARES rheometer (available from TA Instruments, New Castle, Del.) and closed to a gap of ˜1 mm. After scraping off any excess material, the sample was allowed to equilibrate for 12 h at 25° C., after which time a strain sweep was carried out at 0.1 rad/s from 0.02 to 200% strain. The yield stress was interpreted as the stress at the crossover point of the elastic and viscous moduli (G' and G″), according to the method described by Walls, H. J., et al., Yield Stress and Wall Slip Phenomena in Colloidal Silica Gels, J. Rheol., Vol 47, (2003), pp. 847-868. In many embodiments, the interior material 130 is self-supporting and has a yield stress value of 100 dyn/cm² or greater, or 250 dyn/cm² or greater, or 500 dyn/cm² or greater, or 750 dyn/cm² or greater, or 1000 dyn/cm² or greater. In many embodiments the interior material 130 does not flow under the force of gravity. In some embodiments, the interior material 130 is a liner or cement material.

In the illustrated embodiment, the multilayer dental article is a preformed crown 101 and is in the shape of a molar. The external layer surface 110 includes mesial and distal surfaces 112, buccal and lingual surfaces 114, an occlusal surface 111 and a gingival margin 113.

FIG. 3 is a schematic cross-sectional view of another illustrative preformed malleable multilayer dental crown 201. The preformed malleable multilayer dental crown 201 is also referred to as a self-supporting multilayer hardenable preformed dental crown 201.

The preformed malleable multilayer dental crown 201 has an external layer 220 defined by an external layer surface 210. The external layer surface 210 defines an interior volume 215. The interior material 230 is disposed within the interior volume 215. In this illustrated embodiment, the interior material 230 substantially fills the interior volume 215.

The external layer 220 is formed from the hardenable composition described above. This hardenable composition has sufficient malleability such that the preformed malleable multilayer dental article exterior shape can be altered by the application of pressure onto the external layer 220.

The interior material 230 is different than the material that forms the external layer 220, as described in relation to FIG. 2.

In the illustrated embodiment, the multilayer dental article is a preformed crown 201 and is in the shape of a molar. The external layer surface 210 includes mesial and distal surfaces 212, buccal and lingual surfaces 214, an occlusal surface 211 and a gingival margin 213.

FIGS. 4A-4D are schematic cross-sectional diagrams of one illustrative method of using the preformed malleable multilayer dental article 301. In the depicted method, a multilayer incisor crown 301 is utilized. It should, however, be understood that the multilayer crown 301 can have any dental shape to mimic, for example, an incisor, canine, pre-molar, or molar. The multilayer crown 301 includes an external layer 320 and an internal material 330, where the external material and internal material are describe above.

The multilayer crown 301 is advanced in the direction of arrow 352 as depicted in FIG. 4A and pressed onto a prepared tooth 350 having a prepared tooth surface 351 to form a recess 303 in the interior material 330. The recess 303 is defined by a recess surface 321 that can be generally complimentary to the prepared tooth surface 351, as desired. The prepared tooth includes a tooth root 355 disposed within gingiva 380. In many embodiments, the recess surface 321 is in intimate contact with the prepared tooth surface 351. Thus, the recess surface 321 forms a shape that is independent of the external crown surface. In some embodiments, the interior material 330 is partially or fully cured via a radiation source 390. Radiation from the radiation source 390 can transmit through the external layer 320 and partially or fully cure the internal material 330.

Once the recess surface 321 is formed (and interior material 330 partially or fully cured), the multilayer crown 301 is removed from the prepared tooth 350 in the direction of arrow 353 as depicted in FIG. 4B. In some embodiments, the recess surface 321 does not adhere to the prepared tooth surface 351. In some embodiments, both the interior material 330 and the external material layer 320 independently or simultaneously partially or fully cured before the multilayer crown is removed in the direction of arrow 353.

As shown in FIG. 4C, an adhesive or cement layer 370 is optionally disposed on the prepared tooth surface 351. It should, however, be understood that the adhesive or cement layer 370 can be disposed on the recess surface 321 or both the recess surface 321 and the prepared tooth surface 351, as desired. In other embodiments, the interior material 330 adheres to the prepared tooth surface 351, and thus the cement layer 370 is not required.

The multilayer crown 301 is advanced in the direction of arrow 354 as depicted in FIG. 4C and placed onto the prepared tooth surface 350 such that the optional adhesive or cement layer 370 is disposed between the prepared tooth surface 351 and the recess surface 321 to form an adhered multilayer crown.

The adhered multilayer crown can then be fitted and trimmed, and then finally cured with a radiation source 390, if necessary, to form a hardenable multilayer dental crown 302. In some embodiments, the hardened dental article external shape can be altered, to form an altered external crown shape, during the fitting process, as desired.

FIG. 5 is a schematic cross-sectional view of an illustrative packaged dental article. The dental article is described herein and can include an external layer 420 formed of a self-supporting hardenable preformed material described herein and an interior material 430 disposed within the interior volume of the external layer 420, as described above. The dental article is packaged or sealed between a first liner layer 406 and a second liner layer 407. The first liner layer 406 and the second liner layer 407 are described above. These packaged dental articles can be sealed between the liner layers by a manufacture. A dental technician can remove the dental article from the liner layers prior to pressing the dental article onto a prepared tooth, and the like.

All US patents and US patent publications referred to herein are incorporated by reference to the extent they do not conflict. The present invention should not be considered limited to the particular examples described above, but rather should be understood to cover all aspects of the invention as fairly set out in the attached claims. Various modifications, equivalent processes, as well as numerous structures to which the present invention may be applicable will be readily apparent to those of skill in the art to which the present invention is directed upon review of the instant specification.

### EXAMPLES

Unless otherwise noted, all reagents and solvents were or can be obtained from Sigma-Aldrich Corp., St. Louis Mo.

As used herein,

“HEMA” refers to 2-hydroxyethyl methacrylate;

“PETMA” refers to pentaerythritol trimethacrylate;

“TEGDMA” refers to triethylene glycol dimethacylate;

“bisGMA” refers to 2,2-bis[4-(2-hydroxy-3-methacryloyloxypropoxy)phenyl]propane;

“TONE-IEM” refers to the reaction product of TONE 0230 (a polycaprolactone polyol available from The Dow Chemical Co., Midland, Mich.) and 2-isocyanatoethyl methacrylate (available from Sigma-Aldrich Corp., St. Louis, Mo.), as described in U.S. Pat. No. 6,506,816;

“CABOSIL M-5” refers to CABOSIL M-5, a fumed silica available under the trade designation CAB-O-SIL M-5 from Cabot Corp., Boston, Mass.;

“TPEG-990” refers to a CARBOWAX trifunctional polyethylene glycol, available from The Dow Chemical Co., Midland, Mich.;

“FILLER A” refers to a silica-zirconia filler prepared essentially as described in U.S. Pat. No. 6,030,606, and having an average particle size of approximately 0.6 micrometer.

“TINUVIN” refers to a polymerizable UV stabilizer available under the trade designation TINUVIN R 796 from Ciba Specialty Chemicals, Tarrytown, N.Y.;

“IRGACURE 819” refers to a photoinitiator available from Ciba Specialty Chemicals, Tarrytown, N.Y.;

“FILLER B” refers to a silane-treated nano-sized silica having a nominal particle size of approximately 20 nanometers, prepared essentially as described for FILLER F in U.S. Patent Publication No. 2005/0252413.

### Preparative Example 1

### Preparation of a Curable Malleable Dental Composition

A mixture of bisGMA (2.744 g), TONE-IEM (1.476 g), CABOSIL M-5 (0.146 g), TPEG 990 (0.114 g), and Filler A (14.484 g), having, based on the combined weights of the bisGMA and TONE-IEM, 1.49 weight percent TINUVIN, 0.17 weight percent camphorquinone, 0.99 weight percent ethyl 4-N,N-dimethylaminobenzoate, 0.15 weight percent buylated hydroxytoluene, and 0.5 weight percent diphenyliodonium hexafluorophosphate (available from Alfa Aesar, Ward Hill, Mass.), was heated at approximately 85° C. for approximately 20 minutes and was then mixed three times for one minute each using a Model DAC 150 FVZ SpeedMixer (manufactured by FlackTek, Inc., Landrum, S.C.) at 3000 rpm to afford a curable malleable dental composition.

### Preparative Example 2

### Preparation of a Curable Malleable Dental Composition Containing a Pigment

A mixture of bisGMA (2.019 g), TONE-IEM (1.742 g), CABOSIL M-5 (0.388 g), TPEG 990 (0.108 g), Filler A (13.741 g), and a red pigment dispersion of iron oxide in bisGMA/TEGDMA (0.662 g), having, based on the combined weights of the bisGMA and TONE-IEM, 1.49 weight percent TINUVIN 796, 0.17 weight percent camphorquinone, 0.99 weight percent ethyl 4-N,N-dimethylaminobenzoate, 0.15 weight percent buylated hydroxytoluene, and 0.5 weight percent diphenyliodonium hexafluorophosphate (available from Alfa Aesar, Ward Hill, Mass.), was heated at approximately 85° C. for approximately 20 minutes and was then mixed for one minute using a Model DAC 150 FVZ SpeedMixer (manufactured by FlackTek, Inc., Landrum, S.C.) at 3000 rpm. The mixture was then stirred by hand using a spatula, and was then mixed twice more for one minute each using the SpeedMixer to afford a curable malleable dental composition containing a pigment.

### Preparative Example 3

### Preparation of a Bisgma Mixture

A bisGMA mixture was prepared by combining 100 parts by weight of bisGMA, 0.18 parts by weight CPQ, 0.52 parts by weight DPIHFP, 1.03 parts by weight EDMAB, 0.16 parts by weight BHT, and 1.55 parts by weight TINUVIN, heating the mixture to approximately 60° C., and stirring the warmed mixture with a mechanical stirrer for approximately four hours.

### Preparative Example 4

### Preparation of a Tone-IEM Mixture

A TONE-IEM mixture was prepared by combining TONE-IEM (200.0 g), CPQ (0.351 g), DPIHFP (1.035 g), EDMAB (2.068 g), BHT (0.311 g), and TINUVIN (3.10 g), heating the mixture to approximately 60° C., and stirring the warmed mixture with a mechanical stirrer for approximately four hours.

### Preparative Example 5

### Preparation of a Methacrylate-Based Curable Dental Composition

A multifunctional methacrylate resin was prepared by the reaction of HEMA, PETMA, and the isocyanurate of hexamethylene diisocyanate (which is available under the trade designation DESMODUR N 3300 from Bayer MaterialScience AG, Leverkusen, Germany), according to the method described in U.S. Pat. No. 4,648,843. A mixture of this resin (60 parts by weight), TEGDMA (40 parts by weight), camphorquinone (0.18 parts by weight), diphenyliodonium hexafluorophosphate (0.52 parts by weight), ethyl 4-N,N-dimethylaminobenzoate (1.03 parts by weight), buylated hydroxytoluene (BHT, 0.16 parts by weight), and TINUVIN 796 (1.55 parts by weight) was heated to approximately 50° C. and was mechanically stirred for approximately two hours. A portion of this mixture (2.97 g) was then combined with the product of Preparative Example 4 (1.08 g) and the product of Preparative Example 5 (1.35 g). Into this mixture there was then combined Filler A (6.26 g), and FILLER B (8.34 g).

### Preparative Example 6

### Preparation of a Curable Malleable Dental Composition

A bisGMA resin mixture was prepared by combining bisGMA (20.0 g), IRGACURE 819 (0.07 g), buylated hydroxytoluene (BHT, 0.06 g), and TINUVIN 796 (0.62 g), heating the mixture to approximately 85° C. for approximately twenty minutes, and mixing using a SpeedMixer at 3000 rpm for approximately one minute. A portion of this bisGMA resin mixture (1.88 g) was combined with bisGMA (0.14 g), TONE-IEM (1.74 g), TPEG-990 (0.11 g), CABOSIL M5 (0.39 g), and Filler A (13.74 g). This mixture was then heated to 85° C. for approximately 20 minutes, and was mixed three times for one minute each using a Model DAC 150 FVZ SpeedMixer a curable malleable dental composition.

### Example 1

### Preparation of a Two-Layer Curable Malleable Solid Crown Having a Flat Base

An impression of a polycarbonate maxillary right central incisor crown (No. 100, available from 3M ESPE Dental Products, St. Paul, Minn.) was made using IMPRINT II vinyl polysiloxane impression material (available from 3M ESPE Dental Products, St. Paul, Minn.). The polycarbonate crown was then removed from the set impression material to provide a mold for forming the solid curable malleable solid crown. Approximately 5-millimeter long slits were cut through the base of the mold (the marginal edge of the crown) on opposite sides along the mesial-distal line using a razor blade. After the dental composition of Preparative Example 1 was heated in an oven at approximately 80° C. for approximately five minutes, a portion of it was pressed into a sheet having a thickness of approximately 1.5 millimeters. The a portion of sheet was wrapped around the 4-millimeter diameter end of a tapered rod that was made from a vinyl polysiloxane putty dental impression material (available under the trade designation “EXPRESS STD” from 3M ESPE Dental Products, St. Paul, Minn.). The wrapped tapered rod was inserted into the mold and then the rod was removed, leaving the dental composition at the bottom (i.e., the closed end) of the mold. The dental composition of Preparative Example 2 was then heated in an oven at approximately 80° C. for approximately five minutes, and then the mold was filled with this composition to afford a mold that was partially filled with each of the dental compositions of Preparative Examples 1 and 2. The base of the filled mold was then pressed against a flat surface to provide a molded two-layer solid curable malleable crown with a flat base. Excess dental composition was trimmed from the filled mold using a razor blade. The filled mold was placed in a refrigerator at a temperature of approximately 4° C. for approximately 20 hours, and then the mold was peeled off of the molded dental composition to afford a two-layer curable malleable solid crown having a flat base. The curable malleable solid crown was placed on a prepared central incisor model in a typodont and was shaped using conventional composite shaping instruments to provide customized shape and fit in the typodont. The two-layer curable malleable crown was partially- and then fully cured using the procedure essentially as described in Example 1. The cured two-layer crown was then placed on the prepared central incisor model in the typodont and was found to have an intimate fit with the prepared incisor model.

### Examples 2-5

### Preparation of Curable Malleable Crowns Having Curable Liners

Four uncured malleable crowns, each designed for an adult mandibular molar, were prepared essentially as described in U.S. Patent Publication No. 20050040551. Approximately 30 mg of a shade B1 composite restorative (available under the trade designation FILTEK SUPREME XT FLOWABLE RESTORATIVE from 3M ESPE Dental Products, St. Paul, Minn.) was applied using a brush to the interior occlusal surface of each crown to provide four two-layer curable malleable crowns. A cast alloy metal tooth prep was cleaned by sandblasting, rinsing with water, and drying in air and was mounted in an adult typodont. One or two drops of water were placed in each crown, and then each crown was sequentially fitted on the prep and then the occlusal height, interproximal contacts, and shoulder margins of each crown were shaped and customized for the typodont using conventional dental tools. Each crown was then partially cured using a Model XL2500 dental curing light (obtained from 3M ESPE Dental Products, St. Paul, Minn.) for two seconds each on the buccal, occlusal, and lingual surfaces of the crown in the typodont. After each partially cured crown was removed from the alloy metal tooth prep, it was placed on and removed from (a few times each) another metal tooth prep to which it would be cemented. Each of the four crowns was thus fitted to one of four metal tooth preps. Each crown was then cured using a Model XL2500 dental curing light for ten seconds on each of the six sided of the crown. Each of the four cured crowns was then contoured and finished at the margin with a carbide bur, and was subsequently polished using a rubber wheel and a bristle brush. Two of the cured crowns (Examples 2 and 3) were cemented to their respective tooth preps using RELYX TEMP NE cement (available from 3M ESPE Dental Products, St. Paul, Minn.) following the procedure provided by the manufacturer. After the crowns were filled with cement and were seated on the tooth preps, they were heated in an oven at 37° C. for twelve minutes. After removal from the oven, excess cement that had flowed down the walls of the crown as it was seated on the tooth prep was removed from the margins using a dental scaler. The remaining two cured crowns (Examples 4 and 5) were cemented to their respective tooth preps using RELYX UNICEM cement (available from 3M ESPE Dental Products, St. Paul, Minn.) following the procedure provided by the manufacturer. After the crowns were filled with cement and were seated on the tooth preps, the cement was cured using a Model XL2500 dental curing light for two seconds on each of the four sides along the gingival ridge. Excess cement that had flowed down the walls of the crown as it was seated on the tooth prep was removed from the margins using a dental scaler, and then the samples were heated in an oven at 37° C. for five minutes.

### Example 6

### Preparation of a Two-Layer Curable Malleable Crown

One uncured two-layer malleable crown, designed for an adult mandibular molar, was prepared essentially as described in U.S. Patent Publication No. 20050040551. A composite restorative (29.2 mg, shade B1, available under the trade designation FILTEK SUPREME XT FLOWABLE RESTORATIVE from 3M ESPE Dental Products, St. Paul, Minn.) was applied using a brush to the interior occlusal surface of the crown to provide a two-layer curable malleable crown. The two-layer crown was then left to stand at room temperature, occlusal side down, such that the composite restorative did not flow from the interior occlusal surface, for approximately one week. A cast alloy metal tooth prep was cleaned as described above. A small amount of petroleum jelly was applied to the metal tooth prep and then the curable malleable crown was trimmed, seated on the tooth prep, and contoured. The composite restorative was observed not to have flowed past the gingival margin of the crown. The crown was then partially cured using a Model XL2500 dental curing light (obtained from 3M ESPE Dental Products, St. Paul, Minn.) for ten seconds on the occlusal surface and approximately three seconds on each of the buccal and lingual surfaces of the crown. The crown was the removed from the tooth prep using pliers, a process that did not result in damage to the crown nor transfer of material to the tooth prep.

### Example 7

### Preparation of a Two-Layer Curable Malleable Crown

One uncured two layer malleable crown was prepared essentially as described in Example 6, except that 74.9 mg of a composite restorative (shade B1, available under the trade designation FILTEK SUPREME XT FLOWABLE RESTORATIVE from 3M ESPE Dental Products, St. Paul, Minn.) was applied using a brush to the interior occlusal surface of the crown to provide a two-layer curable malleable crown. When the uncured crown was seated on the tooth prep, essentially as described in Example 6, some of the composite restorative was observed to flow past the gingival margin. The crown was not cured.

### Examples 8-10

### Preparation of Two-Layer Curable Malleable Crowns

Each of the two-layer curable malleable crowns of Examples 8-10 were prepared (molded) by first placing a weighed sample of a first curable composition in a pocket formed in a sheet of poly(ethylene-co-vinyl acetate) film, forming a depression in the sample of curable composition, placing a weighed sample of a second curable composition in the depression, and then using either a three-part mold (Example 9) or a four-part mold (Examples 8 and 10) essentially as described in U.S. Patent Publication No. 20050040551. The composition of each crown is given in Table 1, which lists the identity and weights of the components of each crown. In Table 1, the terms “external” and “interior” refer to the external and interior layers, respectively, of each crown, and the weights of each external and interior material are given in parentheses in the column that identifies the materials.

TABLE 1
Compositions of Curable Malleable Crowns of Examples 8-10.

| Example | External Layer | Interior Layer |
|---|---|---|
| 8 | Preparataive Example 1 (0.3 g) | Preparative Example 2 |
| | | (0.1 g) |
| 9 | Preparataive Example 5 (0.23 g) | Preparataive Example 1 |
| | | (0.22 g) |
| 10 | Preparataive Example 1 (0.52 g) | Preparataive Example 6 |
| | | (0.15 g) |

1. A dental article comprising:
an external layer formed of a self-supporting hardenable preformed material, the external layer having a dental article shape defined by an external layer surface, the external layer defining an interior volume; and
an interior material disposed within the interior volume, wherein the interior material is different than the external hardenable preformed material and the interior material has a yield stress value of 100 dyn/cm² or greater.

2. A dental article according to claim 1 wherein the dental article is a dental crown.

3. A dental article according to claim 1 wherein the dental article is a dental bridge.

4. A dental article according to claim 1 wherein the dental article is an artificial tooth.

5. A dental article according to claim 1 wherein the external layer consists essentially of the hardenable material.

6. A dental article according to claim 1 further comprising a first liner layer and a second liner layer wherein the external layer and the internal layer is sealed between the first liner layer and the second liner layer.

7. A dental article according to claim 1 wherein the interior material has a different optical property than the external hardenable preformed material.

8. A dental article according to claim 1 wherein the interior material has a different curing property than the external hardenable preformed material.

9. A dental article according to claim 1 wherein the interior material has a different color or opacity than the external hardenable preformed material.

10. A dental article according to claim 1 wherein the interior material does not adhere to a tooth surface.

11. A dental article according to claim 1 further comprising an adhesive material that adheres to a tooth surface, wherein the interior material is disposed between the external hardenable preformed material and the adhesive material.

12. A dental article according to claim 1 wherein the hardenable preformed material comprises:
a resin system comprising at least one ethylenically unsaturated component and a crystalline component;
greater than 60 wt-% of a tiller system; and
an initiator system;
wherein the hardenable composition exhibits sufficient malleability at a temperature of about 15° C. to 38° C.

13. A method of using a self-supporting hardenable preformed dental article comprising:
providing a dental article comprising:
an external layer formed of a self-supporting hardenable preformed material, the external layer having a dental article shape defined by an external layer surface, the external layer defining an interior volume; and
an interior material disposed within the interior volume, wherein the interior material is different than the external hardenable preformed material and the interior material has a yield stress value of 100 dyn/cm' or greater; and
pressing the dental article onto a prepared tooth to form a recess in the interior material defined by a recess surface that is complimentary to the prepared tooth surface.

14. A method according to claim 13 further comprising coating an adhesive layer onto the prepared tooth to form an adhesive coated prepared tooth, for bonding the dental article onto the prepared tooth.

15. A method according to claim 13 further comprising radiation curing the interior material through the external layer.

16. A method according to claim 13 further comprising selectively curing the interior material after the pressing step to form a hardened interior material.

17. A method according to claim 14 further comprising disposing the dental article having the recess surface onto the adhesive coated prepared tooth.

18. A method according to claim 13 wherein the pressing step comprises pressing the dental article onto a prepared tooth to form a recess in the interior material defined by a recess surface that is complimentary to the prepared tooth surface and the recess surface is in intimate contact with the prepared tooth surface.

19. A method according to claim 17 further comprising curing the hardenable preformed dental crown to form a hardened dental article.

20. A method according to claim 13 wherein the providing step comprises providing a dental article sealed between a first liner layer and a second liner layer and further comprising removing the first liner layer and the second liner layer before the pressing step.
